(19) United States
(12) Patent Application Publication
(10) Pub. No.: US 2025/0322660 A1
(43) Pub. Date: Oct. 16, 2025

(54) MOBILE CAMERA-BASED SYSTEM FOR REAL-TIME BASEBALL SWING ANALYSIS

(71) Applicant: Driveline Baseball Enterprises LLC, Kent, WA (US)

(72) Inventors: Adam Bryce BLOEBAUM, Mebane, NC (US); Clayton Harlow THOMPSON, Kirkland, WA (US)

(73) Assignee: Driveline Baseball Enterprises LLC, Kent, WA (US)

(21) Appl. No.: 19/053,687

(22) Filed: Feb. 14, 2025

Related U.S. Application Data
(60) Provisional application No. 63/634,678, filed on Apr. 16, 2024.

(51) Int. Cl. G06V 20/40; A63B 71/06; G06T 5/70; G06V 40/20

(52) U.S. Cl. CPC G06V 20/42; A63B 71/0622; G06T 5/70; G06V 20/46; G06V 40/23

(57) ABSTRACT

A mobile camera-based system and method provides real-time analysis and feedback on baseball swing performance using computer vision and machine learning techniques. The system comprises a mobile application that captures high-frame-rate video of a hitter's swing using one or two smartphone cameras. A custom YOLO-based pose estimation model detects and localizes key points on the bat in each video frame. The extracted bat trajectories are then processed and input into an XGBoost machine learning model to predict critical swing metrics like bat speed, attack angle, and time to contact. The predicted metrics are displayed to the user through intuitive visualizations in the app's interface within seconds of the swing, enabling instant feedback and adjustment. Swing data is stored locally on the device and can be uploaded to a central server for further analysis, aggregation, and reporting.

### CROSS REFERENCE

This application claims priority to U.S. Provisional Application No. 63/634,678, filed Apr. 16, 2024, the content of which is hereby incorporated by reference in its entirety. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### TECHNICAL FIELD

Disclosed embodiments relate to systems and methods for providing real-time analysis and metrics for baseball swings using computer vision and machine learning techniques applied to video captured from mobile device cameras. More specifically, embodiments relate to a mobile application integrating pose estimation models, computer vision processing, and predictive modeling to deliver instant feedback on key baseball swing parameters to facilitate player development.

### BACKGROUND

Analyzing and quantifying baseball swing mechanics is crucial for player development, scouting, and optimizing performance. Conventional methods for capturing and measuring swing data suffer from various limitations. Sensor-based approaches like Blast Motion and Diamond Kinetics require attaching physical sensors to the knob of the bat which can disrupt a player's natural feel. They also involve Bluetooth connectivity challenges and per-sensor costs that hinder scaling. Marker-based motion capture demands expensive specialized lab environments, extensive setup, and laborious data cleaning. Multi-camera stadium installations provide some flexibility but are cost-prohibitive. Moreover, stadium installations are flexible in the sense that they scale for multi-person use well, but aren't flexible in the sense that you can only hit in the batter's box of that stadium, and have to use a company's specific cameras

Therefore, there is a need for an accessible, affordable, and non-intrusive solution that allows players to receive immediate analytical feedback on their swings in any batting practice setting using minimal equipment. A mobile camera-based system leveraging computer vision and machine learning to predict swing metrics in real-time would provide significant advantages. However, technical challenges arise in developing robust algorithms for detecting the bat in video frames, extracting positional information, and inferring biomechanical parameters at a quality level sufficient for meaningful analysis.

### SUMMARY

The disclosed embodiments provide a novel mobile camera-based system and method for real-time baseball swing analysis using advanced computer vision and machine learning techniques. The system allows players to easily capture high-quality video of their swings using one or two smartphone cameras and receive instant feedback on key performance metrics.

An illustrative embodiment provides an innovative mobile camera-based system for real-time baseball swing analysis leveraging advanced computer vision and machine learning technologies. The system enables users to capture high-frame-rate videos of swings via mobile devices equipped with integrated cameras. By employing custom-trained YOLO-based pose estimation models, it accurately detects key points on bats within video frames to extract detailed kinematic trajectories. These trajectories are processed using sophisticated algorithms and fed into a machine learning model to predict critical swing performance metrics such as bat speed, attack angle, and time to contact in real-time. Results are displayed through an intuitive user interface designed for instant feedback while supporting long-term progress tracking via cloud synchronization capabilities. This markerless approach eliminates cumbersome equipment requirements while providing accessible, accurate insights for players at all skill levels to improve their hitting mechanics efficiently.

Advanced computer vision algorithms may be applied to the extracted bat keypoint trajectories to smooth the data and derive additional kinematic features. These processed bat motion descriptors are fed into a highly optimized gradient boosting machine learning model (e.g., XGBoost), which predicts important swing metrics such as bat speed, attack angle, plane angle, and time to contact. The predictive model is trained on a large corpus of sensor-measured ground-truth data, learning the complex mappings between bat movements and the resulting performance outcomes.

The system provides a comprehensive and informative user experience through a custom-built mobile application. The app allows players and coaches to capture new swing videos, view real-time metric predictions overlaid on the video frames, and review past results. Intuitive visualizations and comparisons enable users to quickly identify strengths, weaknesses, and opportunities for improvement. All swing data is securely stored on the mobile device and can be optionally synchronized to the cloud, facilitating long-term progress tracking, multi-device access, and advanced analytics.

Novel aspects and advantages of the illustrative embodiment include: 1. Markerless and sensor-free swing analysis using only mobile device cameras, eliminating the need for expensive and cumbersome external attachments. Players can capture swings in any batting cage or field without changing their equipment or mechanics. 2. Highly accurate and robust 2D pose estimation of the bat using custom deep learning models trained on large, annotated swing datasets. The models generalize well to inexperienced players and conditions, overcoming major sources of edge case errors. 3. Real-time extraction of bat trajectories and prediction of 3D Cartesian bat kinematics (e.g., speed, acceleration, angles) from 2D videos using advanced computer vision and machine learning pipelines. 4. Ability to measure a comprehensive set of swing metrics (bat speed, attack angle, time to contact, etc.) that strongly correlate with hitting performance. Metrics are delivered within seconds of each swing, allowing for actionable adjustments. 5. Flexible and adaptive mobile app interface supporting efficient video capture, auto-trimming, real-time metric display, multi-swing analysis, workout logging, and more. The streamlined user experience is suitable for players and coaches of all levels. 6. Detailed post-session reporting with interactive visualizations, trends, and comparisons to identify patterns and track progress over time. Data-driven insights enable targeted drill selection and long-term development planning. 7. Cloud integration enabling automatic data backup, cross-device syncing, centralized admin control, and aggregation of results from multiple players for team-wide analytics.

In summary, the disclosed embodiments offer a comprehensive solution for accessible, accurate, and actionable baseball swing analysis using standard mobile devices. By harnessing the power of computer vision, machine learning, and cloud computing, the system empowers players and coaches to unlock data-driven insights and accelerate hitting skill development. The unique combination of innovative algorithms, intuitive user experience, and real-time feedback sets the disclosed system apart as a major advance in baseball training technology.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 shows a block diagram illustrating an embodiment of the mobile camera-based baseball swing analysis system.

FIG. 2 shows a flowchart of the real-time swing analysis process performed by the system.

FIG. 3 shows an example setup for capturing swing video data using the mobile camera-based system in an indoor batting cage environment.

FIG. 4 provides a closer view of the mobile app's user interface for displaying real-time swing analysis results.

### DETAILED DESCRIPTION

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The terms “comprise(s),” “include(s),” “having,” “has,” “can,” “contain(s),” and grammatical equivalents and variants thereof, as used herein, are intended to be open-ended transitional phrases, terms, or words that do not preclude the possibility of additional acts or structures. are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. The singular forms “a,” “and” and “the” include plural references unless the context clearly dictates otherwise. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The embodiments set forth below represent the necessary information to enable those skilled in the art to practice the invention and illustrate the best mode of practicing the invention. For the measurements listed, embodiments including measurements plus or minus the measurement times 5%, 10%, 20%, 50% and 75% are also contemplated. For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “substantially” means that the property is within 80% of its desired value. In other embodiments, “substantially” means that the property is within 90% of its desired value. In other embodiments, “substantially” means that the property is within 95% of its desired value. In other embodiments, “substantially” means that the property is within 99% of its desired value. For example, the term “substantially complete” means that a process is at least 80% complete, for example. In other embodiments, the term “substantially complete” means that a process is at least 90% complete, for example. In other embodiments, the term “substantially complete” means that a process is at least 95% complete, for example. In other embodiments, the term “substantially complete” means that a process is at least 99% complete, for example.

The term “substantially” includes a value that is within 10% less than or greater than the indicated value. In certain embodiments, the value is within 5% less than or greater than of the indicated value. In certain embodiments, the value is within 2.5% less than or greater than of the indicated value. In certain embodiments, the value is within 1% less than or greater than of the indicated value. In certain embodiments, the value is within 0.5% less than or greater than of the indicated value.

The term “about” includes when value is within 10% of the indicated value. In certain embodiments, the value is within 5% of the indicated value. In certain embodiments, the value is within 2.5% of the indicated value. In certain embodiments, the value is within 1% of the indicated value. In certain embodiments, the value is within 0.5% of the indicated value.

In addition, the invention does not require that all the advantageous features and all the advantages of any of the embodiments need to be incorporated into every embodiment of the invention.

### Overview

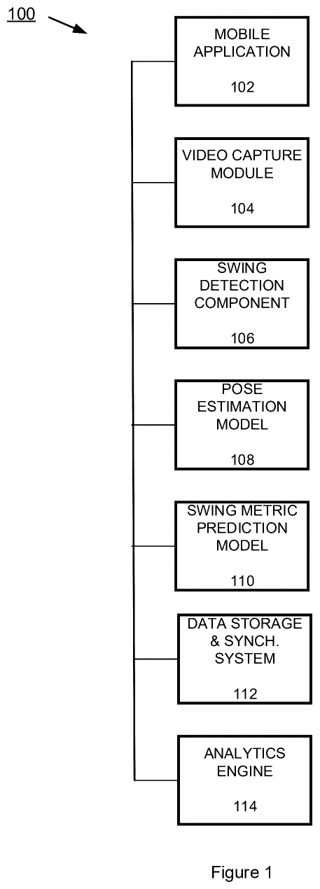

The disclosed embodiments relate to a mobile camera-based system 100 for providing real-time analysis and feedback on baseball swing performance using computer vision and machine learning techniques. With reference to FIG. 1, the system comprises several key components that work together to enable efficient and accessible swing analysis.

At the core of the system is a mobile application 102 that serves as the user interface for capturing swing video, displaying real-time results, and managing data. The app, developed for iOS and Android platforms, provides an intuitive workflow for coaches and hitters to record and review swings using the built-in cameras of a smartphone.

Integrated into the app is a video capture module 104 that leverages the device's camera hardware to record high-frame-rate video of a hitter's swing from the side view. The module offers controls to optimize camera settings based on environmental conditions, ensuring high-quality input data for subsequent analysis steps.

As the hitter takes swings, a swing detection component 106 applies computer vision algorithms to the live video stream to identify and isolate individual swing sequences. Techniques like motion estimation and temporal segmentation enable precise extraction of the relevant frames containing the swing motion.

A pose estimation model then processes the isolated swing video clips 108, which forms a critical component of the system's analysis pipeline. This custom deep learning model, based on the YOLO (You Only Look Once) architecture, is specifically trained to detect and localize key points on the bat in each frame of the swing video. By predicting the 2D pixel coordinates of the bat's barrel tip, knob, and other landmarks, the model extracts rich information about the bat's trajectory throughout the swing.

To translate the raw bat keypoint data into meaningful performance metrics, the system employs a swing metric prediction model 110. This machine learning model, built using the XGBoost algorithm, learns complex mappings between the temporal sequences of bat keypoints and ground-truth values for swing metrics like bat speed, attack angle, and time to contact. By feeding the processed keypoint trajectories extracted by the pose estimation model into the trained metric prediction model, the system can estimate these crucial performance indicators in real-time.

The predicted swing metrics are then visualized and displayed to the user through the mobile app's interface, providing instant feedback and actionable insights. Coaches and hitters can review the quantitative results for each swing just seconds after it occurs, facilitating data-driven adjustments and targeted training.

To support post-session analysis, long-term progress tracking, and large-scale data aggregation, the system includes a data storage and synchronization component 112. Swing data, including video clips, extracted poses, and predicted metrics, is initially stored locally on the mobile device. When an internet connection is available, this data is uploaded to a secure central server, where it is persisted in a structured database. This enables users to access their historical swing data across devices and allows for more advanced analysis and reporting.

Complementing the real-time feedback provided by the mobile app, the system's analytics engine 114 offers extended capabilities for deriving deeper insights from the aggregated swing data. By applying statistical analysis, data mining, and visualization techniques, the engine can uncover patterns, trends, and benchmarks that inform player development strategies. Coaches can access detailed reports and dashboards that summarize a hitter's performance over time, compare them to peer groups, and highlight areas for improvement.

The integration of these components into a cohesive system enables a seamless workflow for capturing, analyzing, and reviewing baseball swing performance data. The mobile form factor, automated analysis pipeline, and real-time feedback mechanisms make the system highly accessible and efficient, empowering coaches and hitters to use data-driven insights in their training. By combining state-of-the-art computer vision and machine learning techniques with baseball domain expertise, the illustrative embodiment brings a new level of precision, objectivity, and scalability to swing analysis, paving the way for data-informed training methodologies and accelerated player development.

### System Architecture

With reference to FIG. 1, a mobile camera-based system 100 for real-time baseball swing analysis comprises the following elements: A mobile application 102 serving as the user interface for capturing swing video, displaying real-time feedback, and managing data. The app is developed for iOS and Android platforms using tools like React Native to enable cross-device compatibility. It provides screens for user login, camera setup, in-session data visualization, and post-session data management. User authentication and backend integration are supported.

A video capture module 104 that accesses the smartphone's built-in camera to record high-frame-rate video of a batter's swing from the side view. The module includes options to configure camera settings like resolution, zoom level, and exposure to optimize video quality for the ambient conditions. It handles details like buffering frames and synchronizing multiple camera feeds. The user is guided through an intuitive interface to properly position the camera(s) for an unobstructed view of the hitting zone.

A swing detection component 106 applies computer vision techniques to identify when a swing has occurred in the video stream. Methods like frame differencing, motion estimation, and temporal segmentation are used to distinguish a swing sequence from the continuous feed. The algorithm is tuned to be sensitive enough to detect subtle movements while avoiding false positives. Once a swing is isolated, its video frames are passed to the pose estimation model for further analysis.

A pose estimation model 108 that predicts the 2D pixel coordinates of key points on the bat in each video frame. A custom deep learning model based on the YOLO (You Only Look Once) architecture is developed specifically for this task. The model is pretrained on a vast annotated dataset of bat images to learn general bat detection capabilities. It is then fine-tuned using domain-specific data containing a wide variety of swing scenarios (bat types, backgrounds, lighting conditions) to achieve precise and reliable keypoint localization. The compact model design enables efficient inference on mobile devices.

A swing metric prediction model 110 that takes the extracted bat keypoint trajectories as input and outputs estimated values for swing performance indicators like bat speed, attack angle, and time to contact. An XGBoost model is trained to capture the complex nonlinear relationships between the positional dynamics of the bat and the resulting swing metrics. The model is fitted using a large corpus of synchronized video and sensor data, learning to map the pose estimation outputs to ground-truth labels. Techniques like cross-validation, feature selection, and hyperparameter tuning are employed to maximize predictive accuracy while avoiding overfitting.

A data storage and synchronization system 112 for persisting swing data on the mobile device and synchronizing with a cloud-based central repository. The system includes a local database to store swing video clips, extracted poses, and predicted metrics for each session. An API facilitates uploading this data securely to backend servers when an internet connection is available. The central database aggregates swing data from all users to support further analysis, reporting, and model improvements.

An analytics engine 114 that computes additional statistics and generates visualizations based on the collected swing data. Metrics like batting average, swing consistency, and performance trends over time are derived through aggregation and statistical analysis. The engine includes algorithms for clustering swings into distinct categories, identifying anomalous patterns, and benchmarking a user's metrics against a larger population. Interactive charts, heat maps, and 3D renderings make the insights easy to interpret.

### Operation

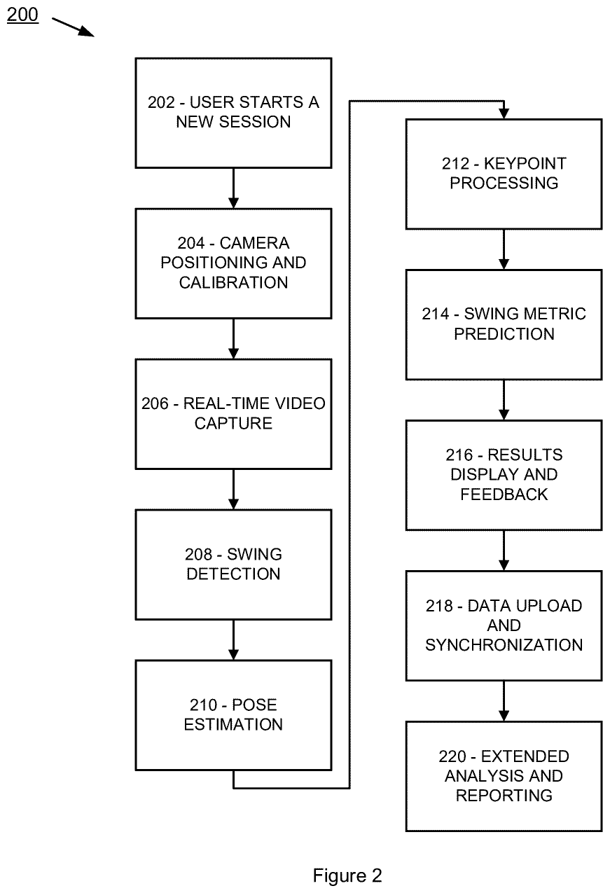

As depicted in FIG. 2, the system's operation follows a series of steps to go from raw video input to real-time swing analysis: 1. User starts a new session (step 202): The coach or hitter launches the mobile application and navigates to the live capture screen. They input basic calibration information like the hitter's handedness and bat length. 2. Camera positioning and calibration (step 204): The app guides the user to correct camera positioning for capturing a clear side view of the hitter's swing. Settings are adjusted for optimal quality. 3. Real-time video capture (step 206): As the hitter takes swings, high-frame-rate video is continuously recorded using the phone's camera(s). This video stream is buffered into the app's memory. 4. Swing detection (step 208): A computer vision algorithm monitors the video stream to identify a swing sequence. Motion analysis techniques like frame differencing, optical flow, and temporal segmentation are applied to isolate the relevant frames bracketing a swing motion. 5. Pose estimation (step 210): The cropped video clip of the detected swing is passed to the pose estimation model. For each frame, the YOLO-based model predicts the 2D positions of key points on the bat, such as the barrel tip and knob. These keypoints are extracted and stored in a structured format. 6. Keypoint processing (step 212): The raw keypoint coordinates are preprocessed to reduce noise, interpolate missing detections, and transform into a common coordinate space. Processing techniques like Kalman filtering and spline fitting may be applied. The smoothed and standardized keypoints are linked into coherent trajectories representing the bat's path. 7. Swing metric prediction (step 214): The processed bat keypoint trajectories are fed into the swing metric prediction model. The XGBoost model takes in the sequential keypoints and outputs estimated values for performance metrics like bat speed, attack angle, and time to contact. These metrics are associated with the originating swing and stored in the database. 8. Results display and feedback (step 216): The predicted swing metrics are displayed to the user in real-time through the app's user interface. Intuitive visualizations like charts, numbers, and color-coded indicators communicate the key results. Coaches and hitters can view the metrics for each swing seconds after it occurs, facilitating instant feedback and adjustment. 9. Data upload and synchronization (step 218): When an internet connection is available, the app uploads the swing data (video, poses, metrics) to a central server for persistent storage. This enables more detailed post-session analysis, long-term progress tracking, and aggregation of data across users for continuous model improvement. 10. Extended analysis and reporting (step 220): The central analytics engine further processes the uploaded swing data to derive higher-level insights. Comparative analysis, trend identification, clustering, and anomaly detection are performed. Dashboards and reports summarizing a hitter's performance over time are generated.

By executing this sequence of steps, the system translates the raw video input from a hitter's session into meaningful and actionable swing insights, all within seconds. The mobile app makes the analysis process accessible by removing the need for specialized equipment or facilities. Hitters can receive quantified feedback on critical aspects of their swing immediately, accelerating the improvement cycle. Coaches gain a powerful tool for objectively assessing a player's technique and progress, enhancing data-driven instruction. Furthermore, the central aggregation of swing data opens up possibilities for large-scale analysis to identify broader patterns and develop data-driven training methodologies. The system's seamless integration of video capture, computer vision, machine learning, and real-time feedback unlocks a new paradigm for baseball training and development.

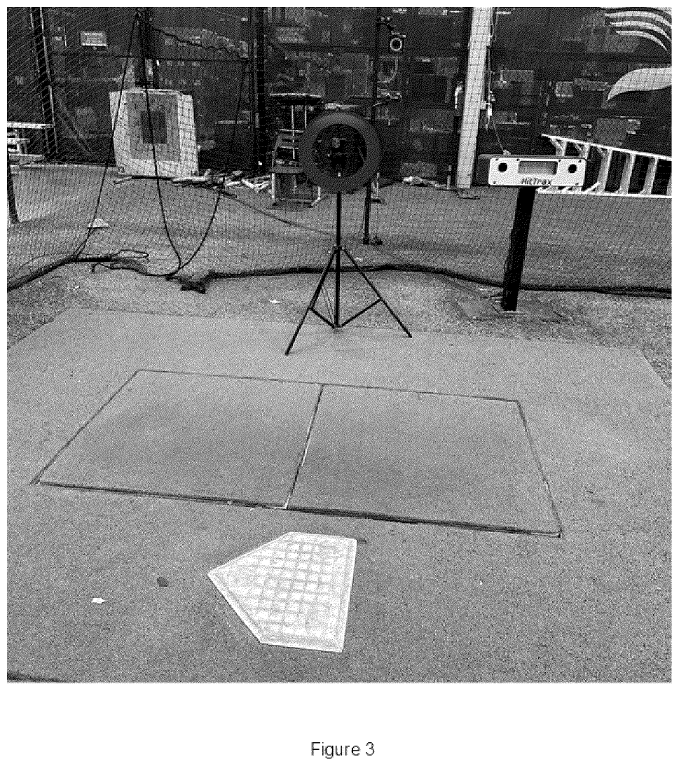

FIG. 3 shows an example setup for capturing swing video data using the mobile camera-based system in an indoor batting cage environment. The key components include: 1. A hitter standing in the batter's box, preparing to swing at a pitched ball. 2. A pitching machine or coach is positioned to deliver pitches to the batter. 3. A home plate and protective L-screen for the pitcher's safety. 4. Artificial turf flooring marked with batter's box lines and a home plate. 5. Netting and protective screens enclosing the batting cage. 6. A tripod-mounted camera or smartphone positioned strategically (e.g., across the other batter's box facing the batter's front) to record a side view of the swing.

The system is capable of operating in various indoor or outdoor training facilities, allowing for convenient data collection and analysis in a controlled environment.

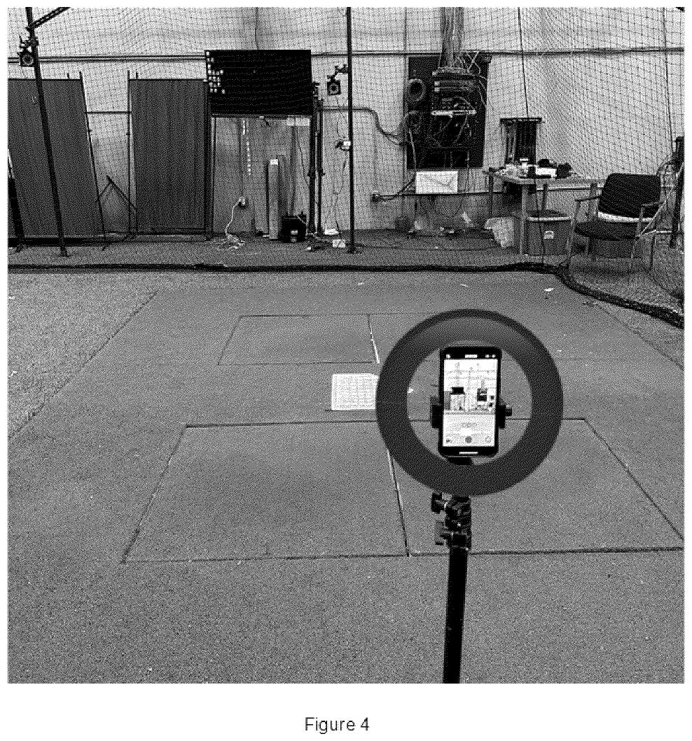

FIG. 4 provides a closer view of the mobile app's user interface for displaying real-time swing analysis results. The key elements for some embodiments include: 1. A smartphone mounted on a tripod or handheld stabilizer, with the camera oriented to capture a side view of the batter's swing. 2. The app's user interface displayed on the smartphone screen, which includes: 2a. A live view of the camera feed, allowing for proper framing and alignment. 2b. Overlay graphics indicating the detected bat position and trajectory. 2c. Real-time display of predicted swing metrics, such as bat speed, attack angle, and time to contact. 2d. Buttons and controls for starting/stopping recording, reviewing previous swings, and adjusting settings. 3. Accessories such as a quick-release phone mount and lens attachment for enhanced stability and video quality.

This figure demonstrates how the mobile app integrates video capture, real-time pose estimation, and instant metric prediction into a user-friendly interface that provides immediate feedback to hitters and coaches.

### Software and AI/ML Components

The software components of the disclosed embodiments form a critical part of the system's functionality and performance. At a high level, the software architecture comprises a mobile application that serves as the primary user interface, a backend server for data storage and extended analytics, and a set of machine learning models for swing analysis.

The mobile application may be developed using a cross-platform framework like React Native or Flutter, enabling deployment on both iOS and Android devices. Alternatively, native apps for each platform could be built using Swift/Objective-C for iOS and Java/Kotlin for Android. The app's user interface is designed to provide an intuitive workflow for capturing swing video, displaying real-time metrics, and reviewing session data.

Integrated into the mobile app is a video processing module, typically implemented using a combination of native APIs (e.g., AVFoundation on iOS) and custom software. This module interacts with the device's camera hardware to capture high-frame-rate video of the hitter's swing from the desired viewpoint. The module may include functionalities like camera configuration, video buffering, and frame extraction.

To detect and isolate individual swing sequences from the continuous video feed, the system may employ a swing detection algorithm. This algorithm could be implemented using computer vision techniques like motion estimation, frame differencing, and temporal segmentation. For example, optical flow methods like the Lucas-Kanade algorithm could be applied to consecutive frames to estimate the velocity of pixels and identify regions of significant motion corresponding to the swing. Alternatively, deep learning-based approaches like convolutional neural networks (CNNs) or recurrent neural networks (RNNs) could be trained to directly classify video frames as containing a swing or not.

Once a swing sequence is detected, the relevant frames are passed to a pose estimation model for extracting bat keypoints. In the disclosed embodiments, a custom YOLO (You Only Look Once) model is used for this task. YOLO is a state-of-the-art object detection architecture that can localize and classify multiple objects in an image in real-time. The model is trained on a dataset of annotated swing images, where the positions of the bat's end points (barrel tip and knob) are manually labeled. During inference, the model predicts the 2D pixel coordinates of these keypoints for each frame in the swing sequence.

To ensure the pose estimation model's robustness and generalization, the training data should be carefully curated to cover a diverse range of scenarios. This includes variations in factors like the hitter's handedness, stance, bat type, environment, and camera settings. Data augmentation techniques like random cropping, flipping, and color jittering can be applied to expand the effective size of the training set. Regularization methods like L1/L2 regularization, dropout, or early stopping can help prevent overfitting. The model's performance should be evaluated on a held-out test set using metrics like mean absolute error (MAE) or percentage of correct keypoint (PCK) to assess its accuracy and reliability.

The raw keypoint predictions from the pose estimation model may contain noise and outliers due to factors like occlusion or motion blur. To mitigate these issues, the system may employ keypoint processing techniques. For example, temporal filtering methods like Kalman filters or moving average filters could be applied to smooth the keypoint trajectories over time. Outlier detection algorithms like RANSAC (Random Sample Consensus) could be used to identify and remove erroneous keypoint predictions. Missing or occluded keypoints could be interpolated using techniques like linear interpolation or spline fitting.

The processed keypoint trajectories serve as input to a swing metric prediction model, which estimates key performance indicators like bat speed and attack angle. In the disclosed embodiments, an XGBoost model is used for this task. XGBoost is a gradient boosting framework that combines an ensemble of decision trees to learn complex non-linear relationships between input features and target variables. The model is trained on a dataset where the input features are derived from the pose estimation model's keypoint predictions, and the target variables are ground-truth swing metrics obtained from reference sensors like Blast Motion.

To train the swing metric prediction model, the input keypoint trajectories may be preprocessed and transformed into a suitable feature representation. This could involve computing summary statistics like mean, variance, and range for each keypoint dimension, or extracting temporal features like velocity and acceleration. Feature engineering techniques like polynomial expansion or interaction terms could be applied to capture non-linear relationships. The model's hyperparameters, such as the number of trees, learning rate, and regularization strength, can be tuned using cross-validation or Bayesian optimization to improve performance.

Similar to the pose estimation model, the swing metric prediction model should be trained on a diverse and representative dataset to ensure robustness and generalization. The dataset should cover a wide range of hitters, bat types, and swing characteristics. Techniques like stratified sampling or oversampling/undersampling can be employed to handle imbalanced data distributions. The model's performance should be evaluated using appropriate metrics like mean squared error (MSE), mean absolute percentage error (MAPE), or R-squared, depending on the specific metric being predicted.

The predicted swing metrics are then visualized and displayed to the user through the mobile app's interface. This may involve generating charts, graphs, or 3D renderings that provide intuitive feedback on the hitter's performance. The app may also include features for comparing metrics across different swings or sessions, tracking progress over time, and setting personalized goals.

To enable more advanced analytics and long-term tracking, the swing data (video, keypoints, metrics) is uploaded to a backend server when an internet connection is available. The server may be implemented using a cloud platform like AWS, Google Cloud, or Microsoft Azure, and can include components for data storage (e.g., Amazon S3, Google Cloud Storage), database management (e.g., MySQL, PostgreSQL, MongoDB), and compute (e.g., AWS EC2, Google Compute Engine). The server's API endpoints can be built using frameworks like Express.js, Flask, or Django REST Framework.

On the server-side, the uploaded swing data undergoes further processing and analysis by an analytics engine. This engine may leverage big data technologies like Apache Spark or Hadoop to handle large-scale data processing and machine learning workloads. Statistical analysis techniques like hypothesis testing, regression analysis, and clustering can be applied to derive insights and identify patterns in the data. Data visualization libraries like D3.js, Matplotlib, or Tableau can be used to create interactive dashboards and reports summarizing a hitter's performance over time.

The integration of these software and machine learning components enables the disclosed embodiments to provide real-time, data-driven feedback on baseball swing performance using only a mobile device's camera. By using state-of-the-art computer vision and machine learning techniques, the system offers a powerful and accessible tool for quantifying and optimizing hitting mechanics, paving the way for data-informed training and player development.

The following subsections address potential issues of a technological nature that may arise in developing an implementation of the inventive system.

### 1. Model Training and Validation

The pose estimation and swing metric prediction models are trained using supervised learning techniques on large, annotated datasets. The data is carefully split into separate training, validation, and test sets to evaluate the models' performance and generalization ability. The training set is used to fit the model parameters, the validation set helps tune hyperparameters and avoid overfitting, and the test set provides an unbiased estimate of the models' performance on unseen data.

During the model development process, techniques like k-fold cross-validation, stratified sampling, and iterative train-test splits are employed to ensure the robustness and reliability of the evaluation metrics. Regularization methods such as L1/L2 regularization, dropout, and early stopping are applied as needed to prevent overfitting and improve generalization.

Particular attention is paid to curating a training dataset that encompasses a wide range of user characteristics and environmental conditions. The pose estimation model is trained on a diverse set of annotated swing videos featuring various body types, skill levels, and batting stances. Data augmentation techniques like rotations, flips, and pixel noise injection are used to expand the effective size of the training set and improve the model's invariance to common perturbations. The model's performance is rigorously tested on a held-out set of swings from players and conditions not seen during training to ensure it can reliably detect and localize bat keypoints across a broad spectrum of real-world scenarios.

### 2. Data Collection and Annotation

The creation of high-quality annotated datasets is crucial for training accurate and robust pose estimation models. The data collection process involves capturing a large number of swing videos from multiple players under varied conditions. The videos are carefully curated to cover a diversity of: A. Player characteristics: body types, heights, batting handedness, stance, and swing style; B. Skill levels: from beginners to professional players; C. Bat types: different weights, lengths, and materials; D. Environments: indoor cages, outdoor fields, varied lighting conditions, and camera angles.

Each video is then annotated frame-by-frame to localize the key points on the bat, such as the barrel end and knob. The annotation process is performed by a team of trained experts with a deep understanding of baseball swing mechanics. A multi-stage quality assurance process is employed where annotations are cross-checked by multiple reviewers and refined through an iterative feedback loop. Statistical techniques are used to assess annotation consistency both within and between annotators.

Crowdsourcing platforms could also be leveraged to scale up the annotation process, but this approach may not be appropriate in some cases. Detailed guidelines, tutorials, and quality control mechanisms should be put in place to ensure the annotations from crowd workers meet the required accuracy standards. The annotated data should be further validated by expert reviewers before being used for model training.

### 3. Real-Time Processing Constraints

Performing correct pose estimation and metric prediction in real-time on mobile devices poses significant computational challenges. The YOLO pose estimation model and XGBoost metric prediction model need to process high-resolution video frames at a sufficient rate to provide instantaneous user feedback.

To meet these real-time constraints, the models are carefully designed and optimized for on-device inference. The YOLO model architecture is tailored to strike a balance between accuracy and speed by using techniques like depthwise separable convolutions, feature pyramids, and anchor box clustering. The model is quantized and compressed to reduce memory footprint and computational complexity without significant loss in accuracy.

The XGBoost model's hyperparameters, such as number of trees and maximum depth, are tuned to achieve the best tradeoff between performance and inference speed. Techniques like feature selection, dimensionality reduction, and pre-aggregation of keypoints are applied to streamline the input data and accelerate prediction.

On the software side, the mobile application is engineered to use GPU acceleration and parallel processing capabilities of modern smartphones. Memory usage is carefully managed to avoid bottlenecks. Computation is offloaded to background threads to keep the user interface responsive. The application also adapts the video resolution and frame rate based on the device's processing capabilities to ensure a smooth user experience.

Rigorous testing is conducted on a wide range of devices to benchmark inference times and optimize the software for different hardware configurations. In cases where the computational requirements exceed on-device capabilities, the system is designed to gracefully degrade by skipping frames or reducing the frequency of predictions to maintain a real-time feel.

### 4. System Robustness and Error Handling

To ensure a reliable user experience, the system incorporates multiple safeguards to handle errors and edge cases in the pose estimation and metric prediction pipeline. The pose estimation model is trained to be robust to common sources of noise and variability in the input video, such as motion blur, partial occlusions, and lighting changes. Data augmentation techniques are used to simulate these perturbations during training.

When processing real-world swings, the system applies a series of filtering and smoothing techniques to the raw keypoint predictions. Temporal smoothing using Kalman filters or LOWESS regression helps reduce jitter and sudden jumps in the estimated keypoints. Outlier detection methods like RANSAC are used to identify and discard anatomically implausible keypoint configurations.

In cases where the pose estimation model fails to detect the bat or yields a low-confidence prediction, the system falls back to interpolation and extrapolation techniques to estimate the likely keypoint locations based on the neighboring frames. If the uncertainty persists for an extended period, the system alerts the user and suggests corrective actions like adjusting the camera position or lighting.

The downstream metric prediction model is designed to be resilient to noisy or missing keypoint inputs. During training, the model is exposed to a range of simulated keypoint imperfections to learn to make accurate predictions even under suboptimal conditions. Confidence intervals and uncertainty estimates are provided alongside the point predictions to convey the reliability of the metrics.

Comprehensive error logging and monitoring systems are put in place to track the performance of the pose estimation and metric prediction models in the wild. Anonymized usage data and error reports are collected from user sessions to identify failure modes and edge cases. This data is used to continually improve the models and make them more robust to real-world conditions.

### 5. Integration of Components

The mobile application serves as the glue that integrates the various components of the system into a seamless user experience. The application is structured as a modular, loosely-coupled architecture to facilitate integration and maintainability.

The video capture module interacts with the device's camera APIs to acquire high-resolution, high-frame rate video of the user's swing. The video frames are buffered in memory and passed to the pose estimation module, which runs the YOLO model to detect and localize the bat keypoints. The keypoint predictions are then filtered, smoothed, and passed to the metric prediction module, which runs the XGBoost model to estimate swing metrics like speed, angle, and contact time.

The predicted metrics and keypoint visualizations are passed to the user interface module, which renders them on the screen and handles user interactions. The data persistence module serializes the annotated video frames, keypoint predictions, and swing metrics and stores them in a local database on the device.

When an internet connection is available, the data synchronization module uploads the locally stored swing data to a central server via a secure REST API. The server ingests the data into a cloud storage system and registers the metadata in a database. The data is then picked up by an asynchronous processing pipeline that performs additional analysis and aggregation.

To ensure a smooth and responsive user experience, the mobile application employs several performance optimization techniques. The video capture, pose estimation, and metric prediction modules run on separate background threads to avoid blocking the main UI thread. The application uses caching and lazy loading techniques to minimize memory usage and reduce startup times. Data compression and serialization techniques are used to minimize the bandwidth usage during upload.

Careful attention is paid to error handling and graceful degradation throughout the integration process. The application uses defensive programming techniques to validate data inputs and outputs at module boundaries. Timeout and retry mechanisms are put in place to handle network failures and server errors during data synchronization.

Comprehensive integration tests are developed to verify the end-to-end functionality of the system under various scenarios. The tests cover common use cases like starting a new session, recording a swing, viewing metrics, and synchronizing data, as well as edge cases like handling interruptions, network failures, and invalid inputs. Continuous integration and deployment (CI/CD) pipelines are set up to automatically run the integration tests and catch regressions before they reach production.

### 6. Security and Privacy Considerations

The system is designed with a strong emphasis on data security and user privacy. All user data, including personal information, swing videos, and analysis results, is encrypted in transit and at rest using industry-standard encryption protocols like AES-256 and SSL/TLS. Access to the data is strictly controlled and limited to authorized personnel only.

When data is uploaded to the central server, it is stored in a secure, access-controlled database. The server infrastructure is hosted in a reputable cloud platform like AWS or Google Cloud, which provide robust security features such as network firewalls, intrusion detection, and regular security audits. All data access is logged and monitored for suspicious activities.

The system is designed to be compliant with relevant data protection regulations such as GDPR and HIPAA. Users are provided with clear privacy policies and terms of service that explain how their data is collected, used, and shared. Users have the right to access, correct, and delete their personal data at any time.

To minimize the risk of data breaches, some embodiments of the system employ several security best practices, such as: A. Strong password policies and two-factor authentication for user accounts; B. Regular security updates and patches for all software components; C. Strict access controls and least privilege principles for system administrators; D. Security audits and penetration testing by independent third parties; and E. Incident response and disaster recovery plans to mitigate potential breaches.

The mobile application also includes several security features to protect user data on the device. The application requires user authentication to access sensitive data and uses secure storage mechanisms like iOS Keychain or Android Keystore to store authentication tokens and encryption keys. The application code is obfuscated and hardened against reverse engineering and tampering attempts.

### 7. Scalability

The system is designed to be highly scalable and able to accommodate a growing user base and increased usage over time. The backend infrastructure is built using modern, cloud-native technologies like Kubernetes and Docker that allow for easy horizontal scaling of services.

The core components of the system, such as the pose estimation and metric prediction models, are designed to be stateless and independently scalable. The models are packaged as Docker containers and deployed on a Kubernetes cluster, which allows for dynamic scaling based on traffic load. The Kubernetes autoscaler automatically adjusts the number of model instances based on CPU and memory utilization, ensuring that the system can handle sudden spikes in usage.

The backend API services are also designed to be stateless and horizontally scalable. The API servers are load balanced using a cloud load balancer like AWS ELB or Google Cloud Load Balancer, which distributes incoming requests evenly across multiple server instances. The API servers are also autoscaled based on request volume and response latency.

The system's data storage layer is designed to handle large volumes of data and high read/write throughput. The swing videos and analysis results are stored in a distributed object storage system like AWS S3 or Google Cloud Storage, which provides high durability and scalability. The metadata and user information are stored in a NoSQL database like MongoDB or Cassandra, which can scale horizontally by adding more nodes to the cluster.

To ensure high availability and resilience, some embodiments of the system employ several reliability best practices, such as: A. Multi-region deployment with failover and disaster recovery capabilities; B. Redundant storage and database replication to protect against data loss; C. Automated monitoring and alerting for key system metrics and error rates; and D. Regular load testing and capacity planning to identify and address performance bottlenecks.

While the system is designed to be highly scalable, there are some potential limitations to consider. The pose estimation and metric prediction models have fixed computational requirements that may limit the maximum number of concurrent users that can be supported on a given hardware configuration. The video upload and processing pipeline may also face bandwidth and storage limitations at exceptionally large scales.

To address these limitations, the system can be further optimized through techniques like model quantization, video compression, and edge computing. The backend infrastructure can also be scaled up by adding more powerful hardware resources or by leveraging specialized accelerators like GPUs or TPUs.

### 8. User Interface (UI) and Experience (UX)

The mobile application is designed with a clean, intuitive, and user-friendly interface that makes it easy for users of all skill levels to capture, analyze, and review their swings. The main screen of the application features a prominent “Record” button that allows users to start a new swing capture session with a single tap.

During the capture session, the application displays a live camera view with real-time feedback overlays. The overlays include visual guides to help the user align their body and the camera for optimal capture. The application also displays real-time metrics like bat speed and attack angle as the user swings, providing instant feedback on their performance.

After the capture session, the application displays a summary screen with key metrics and visualizations for each swing. The metrics are presented in a clear, easy-to-understand format using bold typography and color-coding to highlight important values. The visualizations include 2D and 3D overlays of the user's bat path and contact point, allowing them to see their swing mechanics in detail.

Users can tap on individual swings to view more detailed analysis and compare their performance over time. The application provides interactive charts and graphs that allow users to see trends in their metrics and identify areas for improvement. Users can also tag and filter their swings based on different criteria like session date, location, or bat type.

The application also includes a coaching mode that allows users to share their swing data with a coach or trainer for remote analysis and feedback. Coaches can view their students' swings, add comments and annotations, and create custom training plans based on their performance data.

Throughout the application, care is taken to use clear, concise language and avoid technical jargon that may confuse non-expert users. Contextual help and tutorial overlays are provided to guide users through key features and workflows. The application also includes a comprehensive FAQ section and a way to contact customer support for assistance.

To keep users engaged and motivated, the application includes gamification elements like achievements, leaderboards, and personalized challenges based on their skill level and progress. Users can earn badges and rewards for reaching certain milestones or improving their metrics over time.

The application also prioritizes performance and battery efficiency to ensure a smooth and uninterrupted user experience. The application uses caching and background processing techniques to minimize load times and reduce battery drain during capture and analysis sessions.

### 9. Cross-Device and Cross-Platform Functionality

The mobile application is designed to work consistently across a wide range of smartphones and tablets running both iOS and Android operating systems. The application is developed using cross-platform frameworks like React Native or Flutter, which allow for a single codebase to be deployed to multiple platforms with minimal platform-specific customization.

The application is thoroughly tested on a variety of device models and configurations to ensure compatibility and performance consistency. The application is designed to adapt to different screen sizes and resolutions, with responsive layouts and UI elements that scale and reposition themselves based on the available screen space.

To ensure optimal performance on lower-end devices, the application includes performance optimization techniques like lazy loading, background processing, and memory caching. The application also includes fallback mechanisms and error handling to gracefully degrade functionality in case of hardware limitations or compatibility issues.

The application is designed to leverage platform-specific features and APIs where available, such as ARKit on iOS and ARCore on Android for augmented reality visualizations. However, care is taken to provide fallback implementations and graceful degradation for devices that do not support these features.

The application also includes cross-device synchronization features that allow users to access their swing data and analysis results across multiple devices. User preferences and settings are stored in the cloud and synchronized automatically across devices. The application also supports offline mode, allowing users to capture and analyze swings without an active internet connection, and synchronizing the data to the cloud when a connection becomes available.

While the application is designed to be highly compatible and consistent across devices, there are some potential limitations to consider. Older devices with slower processors or limited memory may experience reduced performance or longer load times for certain features like 3D visualizations or video playback. Some advanced features like augmented reality overlays may not be available on devices without the necessary hardware or software support. The application's user interface and layout may also vary slightly across platforms due to differences in platform-specific design guidelines and UI components.

To address these limitations, the application includes detailed device compatibility information in the app store listing and provides users with clear guidance on the minimum hardware and software requirements for optimal performance. The application also includes user-configurable settings that allow users to adjust performance and quality parameters based on their device capabilities and preferences.

### Example Use Case

To illustrate the application and benefits of the disclosed embodiments, consider the following hypothetical use case involving a collegiate baseball team.

The coaching staff and players of the baseball team adopt the mobile camera-based swing analysis system as part of their training regimen. Each player downloads the app onto their smartphone and attends a setup session where they learn to properly position the camera for capturing side-view swing video.

During regular batting practice sessions, players take turns using the system to record their swings. A teammate or coach holds the phone camera at the appropriate angle as the batter hits balls off a tee or pitched to them. For each swing, the app automatically detects the start and end frames, extracts the bat keypoints using the pose estimation model, and predicts key metrics like bat speed, attack angle, and time to contact using the metric prediction model.

Within seconds of each swing, the app displays the predicted metrics to the player and coach, along with visualizations comparing the results to the player's historical averages and team benchmarks. If a particular swing exhibits suboptimal metrics, like a bat speed slower than the player's norm or an overly steep attack angle, the coach can immediately discuss the results with the player and suggest targeted adjustments.

Note: If a coach is using the app, he or she would have the ability to start multi-user sessions, which may be critical for practice flow in hitting groups. For this purpose, the app could employ facial recognition in addition to manual selection, which could help to manage the flow of players working through the app.

As the batting practice session proceeds, the app builds a database of swings for each player. In between sessions, players can review their swing history, analyze trends over time, and identify areas for improvement. Coaches can access aggregated team data to assess the hitting performance of the squad as a whole and design personalized drills and interventions.

Over the course of the season, the system becomes a critical tool for quantifying players' hitting abilities and development. Coaches leverage the objective data to inform decisions around batting lineup optimization, player positioning, and training priorities. Players gain increased awareness of their swing mechanics and can track their progress as they implement adjustments.

The benefits extend beyond just the team using the system. By participating in data collection initiatives organized by the software provider, the team contributes to the growth of a large-scale hitting database spanning multiple collegiate programs. Researchers and biomechanics experts mine this aggregated data to advance the scientific understanding of effective swing mechanics and glean insights that can be translated into improved coaching practices and player development.

As an illustrative example, consider two hypothetical players on the team: Player A, a freshman outfielder, and Player B, a senior catcher. Player A has raw talent but struggles with consistency in his swing. By using the mobile system to quantify his bat speed and attack angle across hundreds of swings, Player A and his coaches identify a flaw in his initial hand position that is limiting his power. They implement a targeted drill to address the issue, and over the following weeks, the system helps them validate that Player A's average bat speed and exit velocity are significantly improving.

Player B, on the other hand, is recovering from a wrist injury incurred in the previous season. As Player B carefully resumes batting practice, the system allows him to monitor the intensity of his swings and ensure he is not overexerting his recovering joint. Player B's trainers can compare his metrics to his pre-injury baseline and make data-informed decisions about his progression and playing time.

These vignettes demonstrate how the real-time feedback, objective measurements, and longitudinal tracking enabled by the mobile swing analysis system can enhance training, boost performance, and mitigate injury risk for collegiate baseball and softball players. As the system is adopted more widely across teams and institutions, it has the potential to become a valuable tool for coaches and players alike, leveraging data and innovative technology to elevate the game.

### Engineering Solutions and System Calibration

In developing a commercial deployment of the system, in some embodiments Applicant incorporated several novel engineering solutions to overcome critical computer vision challenges in baseball swing analysis:

### 1 Perspective-Aware Scaling

A bat-length-derived scaling factor (scaling_factor-actual_bat_lengthmax_apparent_bat_lengthscaling_factor=max_app arent_bat_lengthactual_bat_length) dynamically adjusts spatial measurements across hitters. This eliminates depth estimation requirements while preserving swing physics by using the bat itself as a reference object2. Maximum apparent bat length detection occurs through frame-by-frame Euclidean distance calculations of keypoint positions.

### 2. Keypoint Confidence Revolution

Statistical analysis of 3,200 annotated frames revealed keypoint predictions remain accurate (<15px error) even with low object detection confidence (threshold: 0.997). This enables:
2A) Independent evaluation of cap/knob keypoints
2B) Targeted interpolation instead of full-frame discards
2C) Retention of motion-blurred frames with valid keypoints

### 3. LOESS Calibration System

A locally estimated scatterplot smoothing technique corrects systematic prediction errors by mapping model outputs to ground-truth sensor data through non-parametric regression. This calibration curve automatically adjusts for speed/angle-dependent biases while maintaining real-time performance.

### 4. Hybrid Contact Detection

For tee swings, a two-stage algorithm combines:
4A) Delta analysis: Detects ball movement initiation via pixel position changes, and
4B) Spatial analysis: Identifies minimum bat-ball distance within delta windows.

This approach works for both right/left-handed hitters without video flipping.

### Alternative Uses and Applications

Beyond providing real-time swing analysis and feedback, the disclosed embodiments also offer valuable capabilities for quantifying hitter workload, tracking swing counts, monitoring long-term development trends, and generating insightful visualizations. These alternative uses extend the system's utility and value for players, coaches, and teams alike.

### Hitter Workload Quantification

The system's ability to capture and analyze swings in real-time enables the automatic quantification of hitter workload during training sessions and games. By counting the number of swings taken and measuring the intensity of each swing based on metrics like bat speed and acceleration, the system can provide a comprehensive assessment of the physical demands placed on the hitter.

This workload data can be aggregated over time to track daily, weekly, or monthly totals, allowing coaches and trainers to monitor hitter fatigue and optimize training regimens. The system can alert coaches when a hitter's workload exceeds predefined thresholds, helping to prevent overuse injuries and ensure adequate rest and recovery.

### Swing Count Tracking

In addition to quantifying overall workload, the system can also provide detailed breakdowns of swing counts based on various criteria. For example, the system can track the number of swings taken in different training contexts (e.g., batting cage, live pitching, tee work), against different pitch types (e.g., fastball, curveball, changeup), or in different game situations (e.g., practice, pre-game warmup, in-game at-bats).

These granular swing counts can offer valuable insights into a hitter's training habits, strengths, and weaknesses. Coaches can use this information to identify areas where a hitter may need additional practice or to optimize their approach based on game situations.

### Long-Term Development Trends

By storing swing data over extended periods, the system enables the tracking of long-term development trends for individual hitters. Coaches and players can visualize how key metrics like bat speed, launch angle, and contact rate evolve over weeks, months, or even years.

This longitudinal data can provide a powerful tool for assessing the effectiveness of training interventions, identifying plateaus or regressions in performance, and setting personalized development goals. By comparing a hitter's progress to age- and skill-matched norms, the system can also benchmark their development against peers and identify potential areas for accelerated training.

### Visualization and Reporting

The system's rich swing data lends itself to a wide range of visualizations and reporting options that can enhance understanding and communication of performance trends. Interactive 3D renderings of swing trajectories can provide a more intuitive and immersive way to explore swing mechanics compared to traditional 2D video analysis. These visualizations can be incorporated into automated reports and dashboards that provide coaches and players with an at-a-glance summary of key performance indicators and trends. Reports can be customized based on specific time periods, training phases, or development goals, and can be easily shared with stakeholders like parents, scouts, or sport science staff.

By leveraging these alternative uses and applications, the disclosed embodiments provide a comprehensive platform for quantifying, analyzing, and communicating the complex dynamics of baseball swing performance. The system's ability to track workload, swing counts, and long-term development trends can help optimize training efficiency, prevent injury, and accelerate skill acquisition. The integration of advanced visualizations and reporting tools can enhance data-driven decision making and streamline communication across all levels of player development.

### Concise Statements of Inventive Features of Some Embodiments

1. A mobile device-based system for real-time baseball swing analysis, comprising: a mobile application, running on a smartphone or tablet, configured to capture high-frame-rate swing video using the device's built-in camera(s); a deep learning-based pose estimation model, integrated into the mobile application, trained to predict the 2D positions of bat keypoints in each frame of the captured swing video; a set of computer vision algorithms for processing the predicted bat keypoint trajectories to extract kinematic features; and a machine learning model, trained on a dataset of bat kinematics and associated sensor-measured metrics, configured to predict one or more swing performance metrics from the processed bat kinematic features.

2. The system of statement 1, wherein the pose estimation model is based on the YOLO (You Only Look Once) architecture and is trained on a large dataset of annotated swing video frames spanning a diverse range of players, bats, and hitting environments.

3. The system of statement 1, wherein the computer vision algorithms include techniques for smoothing keypoint trajectories, interpolating missing or occluded keypoints, and deriving higher-order kinematic features such as velocity and acceleration.

4. The system of statement 1, wherein the machine learning model is an XGBoost gradient boosting model trained to predict metrics such as bat speed, attack angle, plane angle, and time to contact.

5. The system of statement 1, wherein the mobile application includes a user interface for displaying the predicted swing metrics in real-time, comparing metrics across multiple swings, and tracking progress over time.

6. A method for real-time baseball swing analysis using a mobile device, comprising the steps of: capturing high-frame-rate video of a batter's swing using the camera(s) of a mobile device; applying a deep learning-based pose estimation model to predict the 2D positions of bat keypoints in each frame of the captured swing video; processing the predicted bat keypoint trajectories using computer vision algorithms to extract kinematic features; and inputting the processed bat kinematic features into a machine learning model to predict one or more swing performance metrics.

7. The method of statement 6, further comprising the step of training the pose estimation model on a large dataset of annotated swing video frames using a YOLO (You Only Look Once) architecture.

8. The method of statement 6, wherein the step of processing the bat keypoint trajectories includes applying smoothing filters, interpolating missing or occluded keypoints, and deriving higher-order kinematic features.

9. The method of statement 6, further comprising the step of training the machine learning model, using an XGBoost algorithm, on a dataset of bat kinematics and associated sensor-measured metrics.

10. The method of statement 6, further comprising the steps of displaying the predicted swing metrics to the user in real-time, providing functionality for comparing metrics across multiple swings, and tracking progress over time within the mobile application's user interface.

### CONCLUSION

The mobile camera-based system for real-time baseball swing analysis introduced in this disclosure represents a significant advancement in the field of sports technology. By leveraging the power of computer vision and machine learning, the system provides an accessible and effective solution for quantifying and improving swing performance.

Important innovations of the system lie in its ability to accurately detect and track the bat in video frames using a custom YOLO-based pose estimation model, and to predict important swing metrics from the extracted bat trajectories using an XGBoost machine learning model. The development of these models involved careful data collection, labeling, preprocessing, and bias mitigation to ensure robust performance across diverse scenarios.

The system architecture, comprising the mobile application, pose estimation and metric prediction models, data storage and synchronization components, and analytics engine, enables a seamless user experience for capturing, analyzing, and reviewing swing data. The real-time feedback delivered through intuitive visualizations empowers coaches and hitters to make data-informed adjustments and optimize training.

Compared to existing methods for swing analysis, this system offers numerous advantages. The markerless, mobile-based approach eliminates the need for cumbersome sensor attachments or expensive motion capture setups, making it highly scalable. The real-time performance and automated features streamline the analysis process and provide immediate value. By enabling hitters to train in their natural environment with instant feedback, the system accelerates skill development.

Future work will focus on expanding the system's capabilities and applications. Potential enhancements include integrating additional sensors for capturing hitter kinematics, developing more advanced machine learning models for predicting injury risk and optimizing performance, and creating personalized training recommendations based on a hitter's data. Deploying the system across a larger user base will yield a rich dataset for mining insights and refining the algorithms.

In conclusion, this mobile camera-based system for real-time baseball swing analysis showcases the transformative potential of combining computer vision, machine learning, and domain expertise to revolutionize sports training. By providing coaches and hitters with accessible, data-driven tools for quantifying and improving performance, the system paves the way for a new era of baseball development.

We claim:

1. A system (100) for real-time baseball swing analysis, comprising:
a mobile device (102) including a camera (104) configured to capture high-frame-rate video of a batter's swing;
a pose estimation module (108) implemented as a deep learning model trained to detect and localize key points on a bat in each frame of the captured video;
a processing module (110) configured to extract bat keypoint trajectories from the localized key points and generate kinematic features, including velocity and acceleration of the bat;
a machine learning prediction module (112) trained to predict swing performance metrics, including bat speed, attack angle, and time to contact, based on the kinematic features; and
a user interface (114) configured to display the predicted swing performance metrics in real-time and provide visual feedback to the user.

2. The system of claim 1, wherein the pose estimation module (108) is based on a YOLO (You Only Look Once) architecture trained on an annotated dataset of swing video frames.

3. The system of claim 1, wherein the processing module (110) applies temporal smoothing and interpolation techniques to reduce noise and fill missing keypoint data in the extracted bat trajectories.

4. The system of claim 1, wherein the machine learning prediction module (112) is implemented using an XGBoost gradient boosting algorithm trained on ground-truth sensor-measured swing data.

5. The system of claim 1, further comprising a data storage component (116) configured to locally store swing video clips, extracted keypoints, and predicted metrics on the mobile device and synchronize them with a cloud-based server.

6. The system of claim 1, wherein a scaling factor is calculated using a maximum apparent bat length detected across all frames of the swing sequence.

7. The system of claim 1, wherein the machine learning model applies a LOESS calibration curve to predicted bat speeds using ground-truth sensor measurements as calibration targets.

8. The system of claim 1, further comprising a watchdog script that automatically triggers video processing upon detecting new swing recordings in a designated directory.

9. A method for real-time baseball swing analysis using a mobile device (102), comprising:
capturing high-frame-rate video of a batter's swing using a camera (104) integrated into the mobile device;
applying a pose estimation model (108) to detect and localize key points on a bat in each frame of the captured video;
extracting bat keypoint trajectories from the localized key points and generating kinematic features using a processing module (110);
predicting swing performance metrics, including bat speed, attack angle, and time to contact, by inputting the kinematic features into a machine learning prediction model (112); and
displaying the predicted swing performance metrics in real-time through a user interface (114).

10. The method of claim 9, further comprising training the pose estimation model (108) on a dataset of annotated swing video frames using YOLO-based architecture.

11. The method of claim 9, wherein extracting bat keypoint trajectories includes applying temporal filtering techniques to smooth noisy data and interpolating missing values.

12. The method of claim 9, further comprising training the machine learning prediction model (112) using ground-truth sensor data paired with extracted kinematic features from annotated swing videos.

13. The method of claim 9, further comprising storing swing video clips and predicted metrics locally on the mobile device and synchronizing them with cloud storage for long-term tracking and analysis.

14. The method of claim 9, wherein identifying point of contact comprises detecting initial ball movement using frame-to-frame pixel delta thresholds, and calculating sweet spot distances within detected delta windows.

15. The method of claim 9, further comprising filtering keypoint predictions by retaining individual keypoints with confidence scores exceeding a prescribed value (e.g., 0.997) while discarding others for interpolation.

16. A non-transitory computer-readable medium storing instructions that, when executed by a processor in a mobile device (102), cause the mobile device to perform operations comprising:
capturing high-frame-rate video of a batter's swing using an integrated camera (104);
detecting and localizing key points on a bat in each frame of the captured video using a pose estimation model (108);
extracting bat keypoint trajectories from the localized key points and generating kinematic features;
predicting swing performance metrics, including bat speed, attack angle, and time to contact, by processing the kinematic features through a machine learning prediction model (112); and
displaying the predicted swing performance metrics in real-time through a user interface (114).

17. The computer-readable medium of claim 16, wherein the instructions further cause the processor to apply temporal smoothing techniques to reduce noise in extracted bat trajectories before generating kinematic features.

18. The computer-readable medium of claim 16, wherein the pose estimation model (108) is implemented as a YOLO-based deep learning architecture trained on annotated datasets of baseball swings.

19. The computer-readable medium of claim 16, wherein the instructions further cause the processor to store swing data locally on the device and synchronize it with cloud-based storage for extended analysis and reporting.

20. The computer-readable medium of claim 16, wherein displaying predicted metrics includes overlaying visual indicators on captured video frames for intuitive feedback during training sessions.

21. The computer-readable medium of claim 16, wherein the instructions implement selective frame retention by:
preserving cap keypoints with confidence ≥0.997 when knob confidence <0.997; and
preserving knob keypoints with confidence ≥0.997 when cap confidence <0.9972.

22. The computer-readable medium of claim 16, wherein the instructions apply perspective correction by scaling pixel coordinates using a bat-length-derived factor calculated as 34 inchesmax((x2−x1) 2+(y2−y1)2)max((x2−x1)2+(y2−y1)2) 34 inches across all frames.
